(19) United States
(12) Patent Application Publication
(10) Pub. No.: US 2013/0276768 A1
(43) Pub. Date: Oct. 24, 2013

(54) System and Method for Processing Concrete

(71) Applicant: Markus LEER, Stinson Beach, CA (US)

(72) Inventor: Markus LEER, Stinson Beach, CA (US)

(21) Appl. No.: 13/865,080

(22) Filed: Apr. 17, 2013

Related U.S. Application Data
(60) Provisional application No. 61/635,169, filed on Apr. 18, 2012.

(51) Int. Cl. B28D 1/00

(52) U.S. Cl. CPC B28D 1/003
USPC 125/5

(57) ABSTRACT

Disclosed herein is a device and system for processing concrete. Certain embodiments may include a conveyor belt, milling, planning and shaping assemblies, specialized sawing assemblies, and a finishing assembly. The milling, or shaping assembly may be implemented during different phases of the process. Tools would be mounted along the conveyor belt and affixed directly over the conveyor belt, or mounted horizontally along side of the conveyor to produce a shaping or tolerance specification as desired. A tungsten, carbide milling apparatus or diamond grinding drum may be housed in a steel enclosure with a motor or hydraulic direct or belt drive. Next the saw assemblies may be placed and affixed directly over the conveyor belt. The second saw assembly is oriented perpendicularly to the first saw assembly or devices or mechanization may be added to position the concrete prior to entering the sawing machine. Various finishing assemblies are also disclosed.

### PRIORITY

This application claims the benefit of U.S. Provisional Patent Application 61/635,169 by the same inventor filed on Apr. 18, 2012 which is incorporated by reference as if fully set forth herein.

### BACKGROUND

The present invention relates generally to the fabrication of concrete, and more particularly to a system and method for manufacturing and processing recycled concrete blocks to a specific standard.

Recycled concrete conventionally can be taken from interior or exterior slabs, pavement and roadways, sidewalks, driveways, or other construction and demolition waste. The recycled concrete may be removed in the form of broken or cut chunks or unevenly sized blocks. Conventionally, to utilize this recycled concrete, the chunks or unevenly sized blocks are laid in a mosaic manner and impregnated with a type of grout to set the concrete in place in a process commonly referred to as Urbanite. Demolished concrete debris may also be dry stacked or set in place with mortar to create a wall or retaining affect. This process creates a recycled pavement or vertical feature that appears broken or separated and is otherwise rough and unfinished in appearance. To produce a more uniform recycled pavement surface, or building or landscaping material from the recycled or salvaged concrete it must be processed further. An alternate method of recycling the concrete chunks and debris from construction demolition projects, comprising unevenly sized blocks it can be loaded into a large industrial apparatus know as a crusher or impact crusher and crushed to become a coarse aggregate which can be used for a number of things including being mixed with fine aggregates to create a recycled concrete mixture. The recycled concrete mixture is then used as a new concrete mixture that may be mixed, poured, and set. Although this creates a more uniform surface, it requires extra steps and materials to process the recycled concrete and to transform it into recycled pavement.

As such, it may be desirable to have a system and method to manufacture and process recycled concrete in a manner which maintains the integrity of the concrete, and may also produce uniform recycled concrete blocks which may be easily utilized.

### SUMMARY

Disclosed herein is a device which may comprise a conveyor belt, a milling, planning and shaping assembly, a series of one or more specialized diamond sawing assemblies, and a finishing assembly. The milling, planing or shaping assembly may be implemented or utilized at any phase during the process; before, during or after the sawing or finishing process' take place and would be mounted along the conveyor belt and affixed directly over the conveyor belt, or mounted horizontally along side of the conveyor to produce a shaping or tolerance specification as desired. A tungsten, carbide milling apparatus or diamond grinding drum may be housed in a steel enclosure with a motor or hydraulic direct or belt drive. Next the saw assemblies may be placed and affixed directly over the conveyor belt. The second saw assembly is oriented perpendicularly to the first saw assembly or devices or mechanization may be added to position the concrete prior to entering the sawing machine. Lastly a finishing assembly may be coupled to the conveyor belt where tolerances may be refined further by milling, grinding or cutting. The concrete may be cut to shape on up to all 6 sides to produce the desired shape, size or dimension.

In certain embodiments a user may retrieve or receive some recyclable concrete. The concrete is sorted and loaded on a loading or delivery system which is comprised of a steel apron or hopper which provides or allows access so that concrete slabs, blocks or material can be pushed or guided or fed manually or mechanically onto the conveyor or delivery system. This could be, but not limited to, a chain driven delivery system, metal or wood slat conveyor or a conveyor employing rubber belting. The concrete slabs or blocks are put through a series of processes including but not limited to: milling, planing, cutting, shaping, tolerancing and finishing processes. These processed in combination allow for the controlled manufacturing of all sides of a recycled/ re-purposed or reclaimed concrete block, slab, wall or column.

These processes may be arranged in a variety of configurations depending on size and quality of the material, or the desired shape, size and finish of the final product. Other factors that could determine the configuration of machines and process are: site access, site conditions, environmental conditions, or efficiencies dictated by the process. The recyclable concrete passes through three or more sawing or milling appurtenances', which Mills, planes, cuts or grinds the top, side or bottom of a concrete block. This process and machines in combination described within will be the first of its kind. Producing a specific dimension of: height, width, and desired shape of a recycled piece of concrete.

The manufacturing process begins in one of two ways. It is either first planed to a desired and uniform height or it may first be cut into dimensional strips or concrete blocks of a desired width or height. At any point along the process waste may be removed by hand or mechanical means. It may also be desirable during the process to employ further planing, grinding or milling machines to refine the shape and/or tolerance of material. Although the inventor has contemplated certain standardized dimensions, there is no reason to limit this disclosure to any standard sizes.

To further refine the shape and achieve specific tolerances the recyclable concrete is transported down a conveyor and then passes under a sawing assembly. The saws make several cuts to produce strips, blocks or slabs of recycled concrete. These strips, blocks or slabs of recycled concrete are then passed to a second conveyor, which is perpendicularly situated from the first conveyor; or alternately has mechanizations to position the concrete in the desired position to perform precision cutting. Thus the slabs, once transferred to the second conveyor, have been reoriented, for example by turning them 90 degrees from their original position.

The reoriented slabs of recycled concrete may then pass under a second saw assembly, further cutting the recycled concrete into blocks. One or more conveyors may be inclined or angled so that gravity may seat or hold the concrete strips as they rest on a cleat or guide secured to the conveyor belting or deck. Thus ensuring that the concrete strips or blocks maintain a parallel or perpendicular relationship to the saw blades or other shaping apparatus and to ensure precision. Alternate or additional devices that apply pressure downward on a piece of concrete before during or after it is cut may be employed to increase friction between the material and the conveyor belt. Alternatively, the saws may be replaced with hydraulic shears to obviate the second conveyor belt. In some embodiments the second set of hydraulic shears would be oriented perpendicular to the first set of hydraulic shears.

Relief cuts may also be useful during hydraulic shearing to aid and control proper and accurate cleaving or shearing of the concrete and it's aggregate. Once the recycled concrete is in block form it may be turned on its side or top side down manually or by mechanical means on a conveyor belt or mechanical apparatus. The unfinished bottom of the recycled concrete block can pass through a saw or any one of a number of machines to produce a desired finish on the final surface. The recycled concrete block may be passed through a finishing line. This would entail any one of a number of machines such as: a tolerance milling machine, a scarifier grinder, diamond grinders, shot blasting, or another set of saws, to produce the desired texture, style, shape, color.

Further treatment including the application of staining substances in the form of chemical stains, pigment dyes, or the application of additional concrete substances or topping compounds may be desired before the product exits the process. some embodiments may include a tumbler or antiquing device to produce an aged worn or cobbled effect. Dyes, colors or sealers can be applied by a sprayer as the product passes by on a conveyor or the product may be dunked in a tank as it reaches the terminus of the finishing process.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates one facet of a fully assembled embodiment of the system and method for processing concrete.

FIG. 2 illustrates one embodiment of a mill assembly.

FIG. 3 shows a front view of one embodiment of the mill assembly.

FIG. 4 illustrates one embodiment of a saw assembly.

FIG. 5 shows a front view of one embodiment of the saw assembly.

FIG. 6 depicts a side view of one embodiment of the saw assembly.

FIG. 7 depicts one embodiment of rotation on a conveyer system.

FIG. 8 depicts one embodiment of a finishing line.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### Lexicography

Read this application with the following terms and phrases in their most general form. The general meaning of each of these terms or phrases is illustrative, not in any way limiting.

The term “concrete” generally refers to a heavy, rough building material made from a mixture which may contain broken stone, gravel, sand, cement, and water, that can be spread or poured into molds and that forms a stone-like mass on hardening. Concrete may contain aggregate that serves as reinforcement to add strength to the overall composite material. As used herein the term concrete refers to hardened concrete.

In some embodiments concrete is received, sorted and loaded on a loading/delivery system which entails an apron or hopper which provides access so that concrete slabs, blocks or material can be pushed or guided by a conveyor or delivery system. This could be a chain driven delivery system, metal or wood slat conveyor or a conveyor employing rubber belting. The concrete slabs or blocks are put through a series of processes including but not limited to: milling, planing, cutting, shaping, tolerance and finishing processes allowing the controlled manufacturing of all sides of a recycled/ re-purposed or reclaimed concrete block, slab, wall or column.

The processes and equipment described herein may be arranged in a variety of configurations depending on size and quality of the raw material, or the desired shape, size and finish of the final product. Other factors that could determine the configuration or order of machines and process are site access and environmental conditions. The manufacturing process may begin in several ways for example raw material is planed to a desired and uniform height or it may first be cut into dimensional strips or concrete blocks of a desired width or height. Next the concrete may be either planed or milled and cut further by diamond sawing equipment. At any point before or after being cut into dimensional pieces or blocks waste can be removed by hand or mechanical means. It may be desirable at any point during the process to employ a planning, grinding or milling machine to further the shaping and/or tolerance of material.

### System Elements

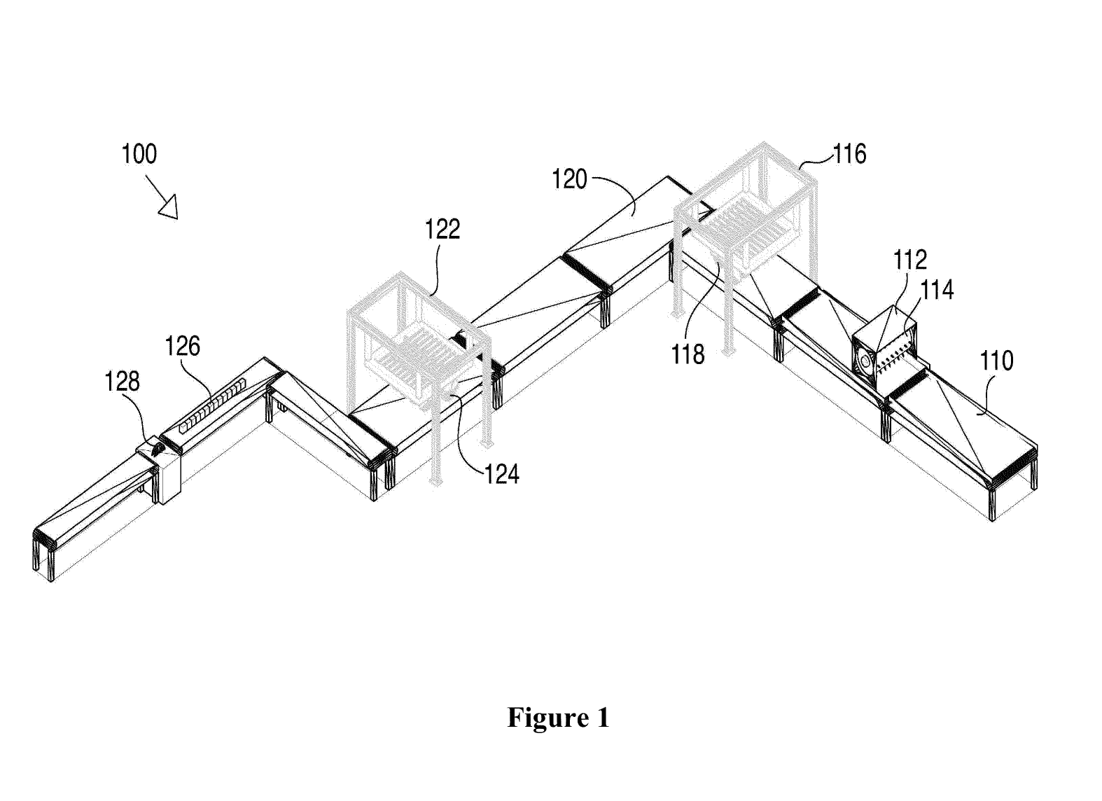

FIG. 1 illustrates certain aspects of a system and method for processing concrete 100. In the FIG. 1 the process for processing concrete begins from the right and is completed on the left. The system and method for processing concrete 100 has at least a first conveyor belt 110 to bear the recycled concrete (the load) and move it along through the process. In some embodiments the conveyers are sized to handle raw material of up to 4 feet by 4 feet and 8 inches high. The inventor contemplates conveyers handling approximately 300 lbs per foot of belt width and moving material at up to 15 feet per minute.

Coupled to and aligned directly above the first conveyor belt 110, is a milling assembly (or grinder) 112. The milling assembly may be adapted from conventionally available concrete milling devices and situated above the conveyer belt 110. The milling assembly houses a mill 114, which grinds and mills the recycled concrete. Depending on the source of the concrete, only a single side may require surface treatment from the mill 112. The size of the grinding surfaces and power of the motor for the mill are determined based on the source of the recyclable concrete, its aggregate, and the required depth of milling which will vary from ⅛″ to several inches thick.

A first saw assembly 116 is aligned directly above the first conveyor belt 110. The first saw assembly 116 having at least one motorized saw blade 118 coupled to it. The saw blade 118 has a position parallel to the first conveyor belt 110. A second conveyor belt 120 is coupled to the first conveyor belt 110 in perpendicular manner to effectuate rotation of material on the conveyer belt. The second conveyor belt 120 changes the direction of movement of material on the conveyer belts. A second saw assembly 122 is aligned directly above the second conveyor belt 120. The second saw assembly 122 having at least one motorized saw blade 124 coupled to it. The saw blade 124 has a position parallel to the second conveyor belt 120. Further along, the system and method for processing concrete 100 has a third conveyor mechanism 126, which turns the recycled concrete on its side. Coupled to the third conveyor mechanism 126 is a saw blade 128.

The system and method for processing concrete 100 has the third conveyor mechanism 126 and the saw blade 128, these elements serve an optional function of creating a recycled concrete block finished on all six sides. Further optional functions include passing the recycled concrete block through a finishing machine, another set of saws, diamond grinders, or shot blasting to acquire varying texture, style, shape, color, control precision and the like. The system and method of processing concrete 100 may be broken down into movable modules for transportation.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Milling Assembly

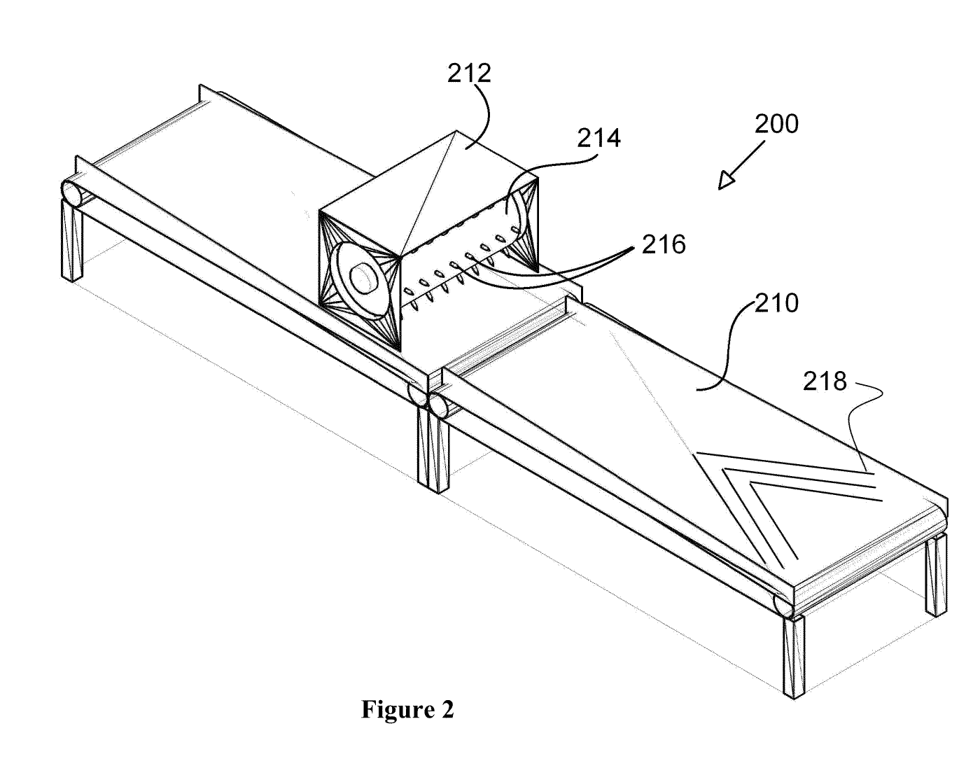

FIG. 2 illustrates one embodiment of a mill assembly 200 (or planer). In the FIG. 2, the milling assembly 200 has a mill housing 212, which is coupled to and aligned directly above a conveyor belt 210. The conveyer belt includes cleats for raising the concrete off the surface of the conveyer belt 210. The mill housing 212 holds a mill drum 214. The mill drum 214 is coupled to the mill housing 212 but can freely rotate along an axis. The mill drum 214 has a plurality of teeth 216 capable of cutting concrete. The plurality of teeth 216 may be effectuated using carbide or other suitable material able to cut through concrete.

In this embodiment the conveyer belt 210 may be formed with cleats 218 to facilitate moving material and sawing. Cleats may be formed from wooden slats or consumable raised material such as plastic or rubber. In operation the cleats act to provide traction to reduce unwanted movement of the concrete while on the conveyer belt. Cleats may also operate to raise the raw concrete material above the normal surface of the conveyer belt to allow for cutting through the entire raw material without harming the conveyer belt. The inventor contemplates have multiple cleats on the surface of the conveyer belt that may have portions cut away during sawing operations.

Certain embodiments may also use conveyer belt material having a top surface which is consumable, supported by a stronger supporting layer. A saw blade may cut into the consumable layer of the conveyer belt 210 without hindering the operation of the conveyer belt 210 because the saw blade will only extend into the consumable layer of the conveyer belt 210 and not the stronger layer. In operation the consumable layer may wear away from the affect of the concrete material or the operation of the saws.

Cleats also operate to allow room for slurry from sawing and milling to be moved away from the concrete because the slurry will fall between the cleats. In some embodiments an air blower or water jet may be employed to remove the slurry from the conveyer belt.

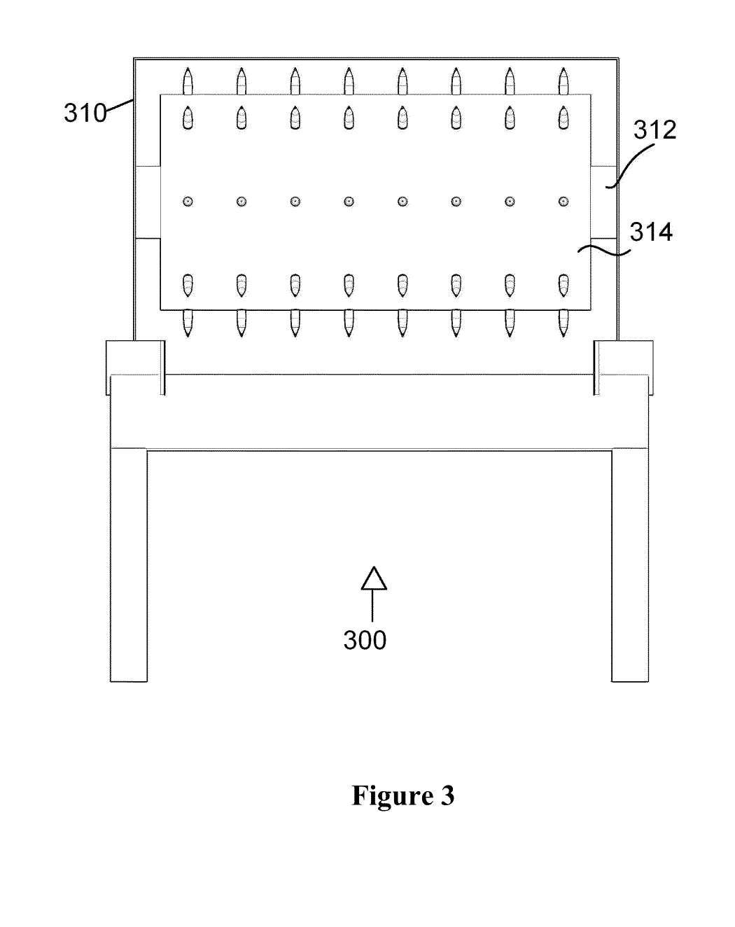

FIG. 3 shows a front view of one embodiment of the mill assembly 300. The milling assembly 300 has a mill housing 310. A mandrel 312 is coupled to the mill housing 310. A mill drum 314 is coupled and freely rotates on the mandrel 312. The milling assembly 300 may be used to cut recycled concrete at varying heights. This is achieved by vertically adjusting the mill housing 310. One having skill in the art will recognize that the milling may be accomplished by a mandrel with sufficient strength and velocity to cold-mill concrete. The mill may be driven by a motor or hydraulically.

### Saw Assembly

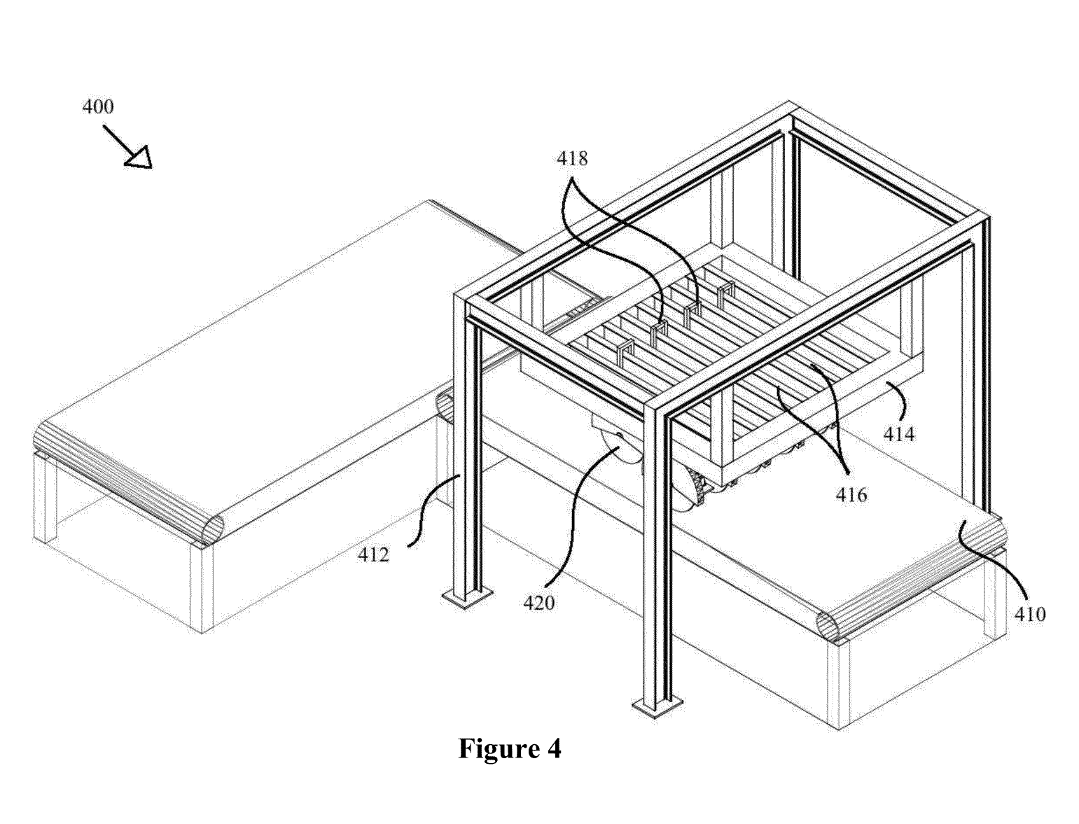

FIG. 4 illustrates one embodiment of a saw assembly 400. The saw assembly 400 has supporting structure 412, which is aligned directly above a conveyor belt 410. The supporting structure 412 is mounted to the same foundation the conveyor belt 410 sits on. The supporting structure 412 may be effectuated using steel tubes or I-beams or other suitable material known to those of ordinary skill in the art. The supporting structure 412 is coupled to a saw mounting frame 414. The saw mounting frame 414 may be coupled to the supporting structure 412 in multiple manners, lower than the supporting structure 412 as depicted in FIG. 4, flush with the top of the supporting structure 412 or any other manner suitable for stabilizing the saw mount frame 414 above the conveyor belts 410. The saw mounting frame 414 has a plurality of saw mounts 416. A plurality of mounting brackets 418 are coupled to the saw mounts 416. The mounting brackets 418 are coupled to a plurality of guide rods (not shown in FIG. 4). These guide rods are each coupled to a saw 420. The saw 420 has a saw motor, blade guard, and a plate on which the motor is coupled to (not shown in FIG. 4). The saw 420 may be effectuated using a diamond blade or other suitable material known to those of ordinary skill in the art used to cut concrete.

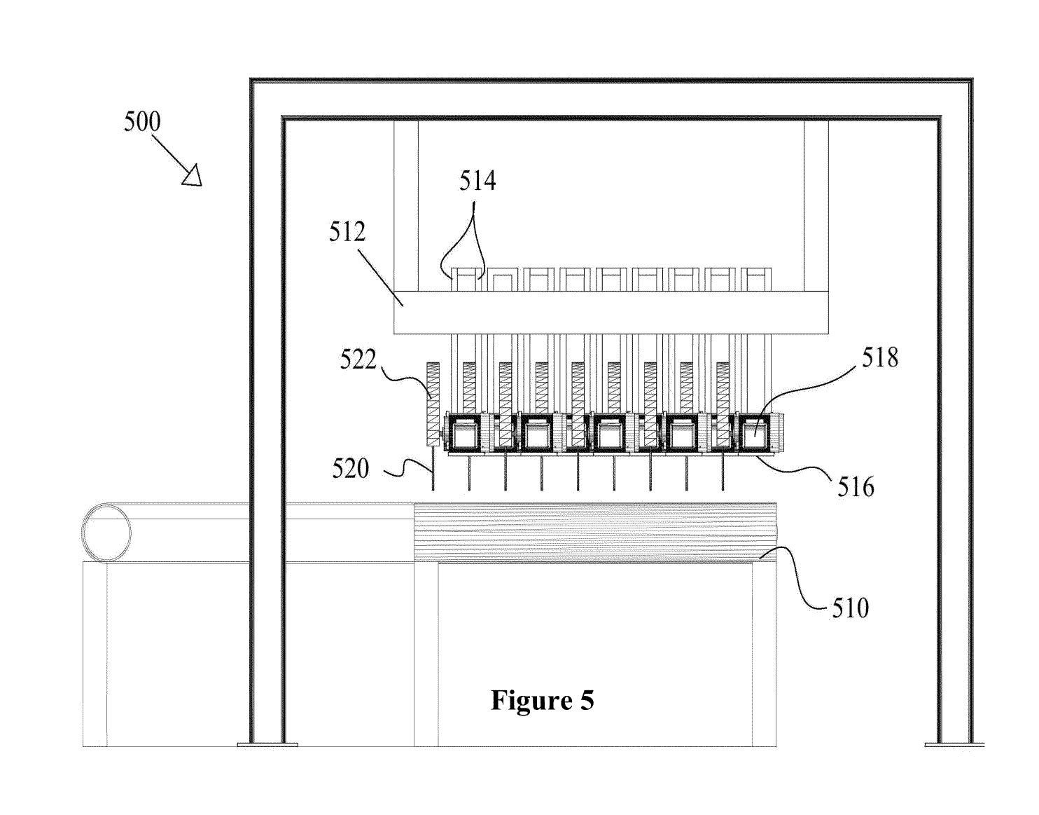

FIG. 5 shows a front view of one embodiment of the saw assembly 500. As described above, the saw assembly 500 has a saw mounting frame 512, which is aligned directly above a conveyor belt 510. The saw mounting frame 512 is coupled to the saw mounts (not shown in FIG. 5), which are in turn coupled to the mounting brackets (not shown in FIG. 5). The mounting brackets are coupled to a plurality of guide rods 514, which are capable of sliding vertically through the mounting brackets. The guide rods 514 are coupled to a plate 516, which holds a saw motor 518. The saw motor 518 is coupled to a saw 520 and a blade guard 522. The saw's 520 height may be adjusted by sliding the guide rods 514 vertically through the mounting brackets. This may be done to accommodate for varying sizes of recycled concrete. The saws may be adjustable thus allowing for different blade sizes to be used and having the effect of producing different thicknesses of concrete. One having skill in the art will appreciate that this may be effect either though a mechanism that controls conveyer motion and holds the saws in place or the entire saw assembly may be adjustable up and down to meet a desired objective.

One having skill in the art will also appreciate that the saw blades 520 may be driven independently by using separate motors for each blade. Driving each blade separately allows for more control over the power per blade and provides for smart cutting of the concrete because a single piece of concrete may be cut in several ways. For example and without limitation different saw blades may be used for different saws and each bladed powered differently depending on the type of cut desired.

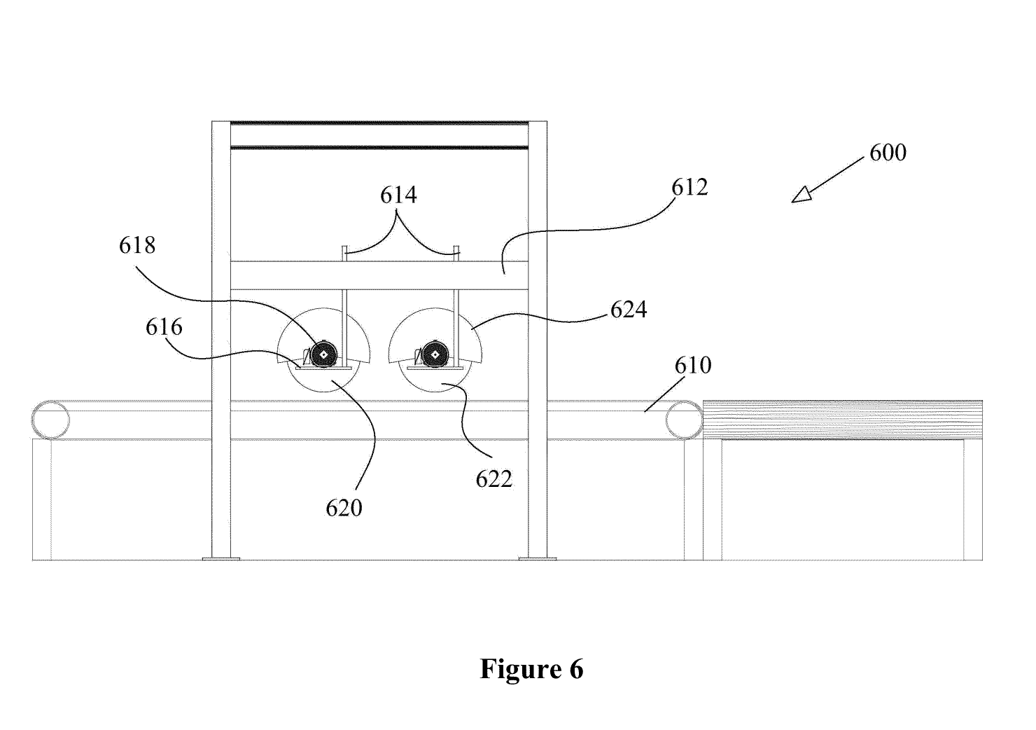

FIG. 6 depicts a side view of one embodiment of the saw assembly 600. As mentioned above, a saw mounting frame 612 is aligned directly above a conveyor belt 610. The saw mounting frame 612 and saw mounts (not shown in FIG. 6) have the capability of coupling to the mounting brackets (not shown in FIG. 6) and guide rails 614 in an offset fashion. A plate 616, a saw motor 618, and a blade guard 624 coupled to a saw 620 are offset from the plate 616, saw motor 618, and blade guard 624 coupled to a saw 622. The offset saws 620 and 622 allow for a closer cut of the recycled concrete between saws 620 and 622 resulting in a narrower finished product.

In operation the user retrieves the recycled concrete and places it on the conveyor belt. The recycled concrete then passes through the milling assembly, which grinds the top of the concrete to a specific height. The recycled concrete is transported down the conveyor and then passes under the first saw assembly. The saws make several cuts to produce slabs of recycled concrete. The slabs of recycled concrete are then passed to a second conveyor, which is perpendicularly situated from the first conveyor. Thus the slabs, once transferred to the second conveyor, have been reoriented 90 degrees from their original position. The reoriented slabs of recycled concrete pass under a second saw assembly, further cutting the recycled concrete into blocks. Alternatively, the saws may be replaced with hydraulic shears to obviate the second conveyor belt. The second set of hydraulic shears would be oriented perpendicular to the first set of hydraulic shears. Once the recycled concrete is in block form it may be turned on its side by a third conveyor belt and the unfinished bottom of the recycled concrete block can pass through a saw to finish the last side. Optionally the recycled concrete block may be passed through a finishing machine, another set of saws, diamond grinders, or shot blasting to acquire varying texture, style, shape, color, control precision and the like.

Finishing may be accomplished according to a predetermined parameter and saws and grinders may be employed to effect a desired result. For example and without limitation different saws may be used to cut pavers to a particularly thin or thick result. Similarly different finishing devices may be employed to cut paver have a desired finish.

### Conveyer System

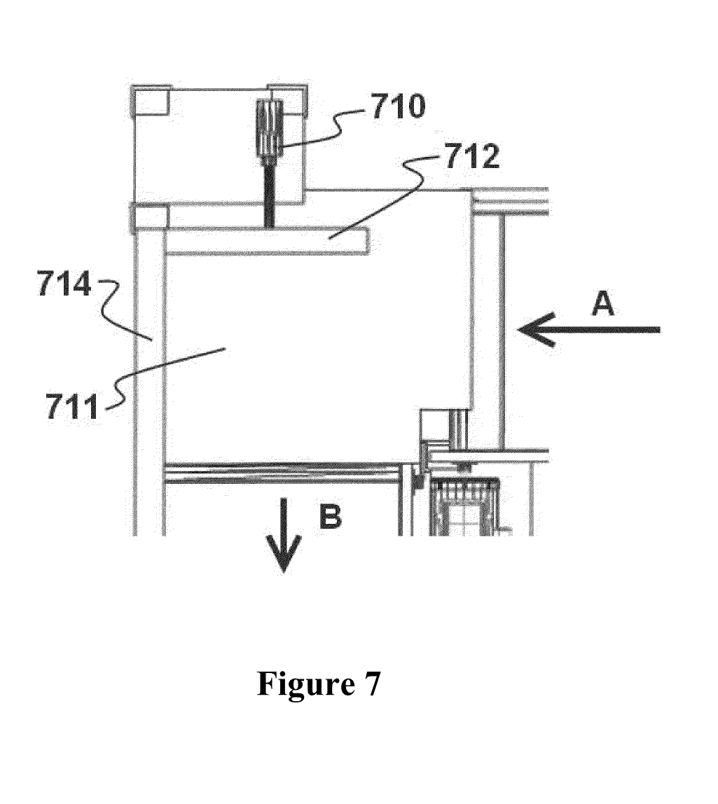

FIG. 7 depicts one embodiment of rotation on a conveyer system. A rotator system may use a series of belts for transferring pieces of material and, in effect, changing their direction of travel. A first conveyer belt may abut a second belt at 90 degree angles. As the material falls off the first belt it lands on another belt changing the front-moving surface of the material. In FIG. 7 a first conveyer belt brings in material in direction A. The material is dropped onto a staging area 711. Once deposited a hydraulically or electrically driven actuator 710 drives a push guide 712 to transfer the material onto a second conveyer belt moving in direction B, thus rotating the direction of travel by 90 degrees.

One having skill in the art will appreciate that one or more rails 714 may be positioned to direction the direction of travel and the amount of effective rotation of the material. The conveyer of FIG. 7 operates for heavy or irregularly shaped material because it provides for more control over the movement of material through a system.

### Cold Planing

Certain embodiments may include a cold planer (also known as a pavement planer, pavement recycler, milling machine or roto-mill). Planers are construction machines conventionally used to remove bituminous pavement or concrete from roadway surface. To effect planning, a cold planer is mounted at a predetermined height above a conveyer carrying material such as concrete. Planing may be accomplished by bringing a rotating mandrel or “head” into contact with the material a predefined depth or slope. The mandrel has numerous hardened spikes (or bits) on its surface, which bite and tear away at the material surface. In some embodiments a water spray system provides cooling for the mandrel, as well as dust management.

In operation two similar devices, sometimes referred to as a mill and a planer, are used in conjunction to effectuate a desired result. For example and without limitation a first step of planning may be performed to rough cut the raw material and then a milling step employed to effect a desired finish.

### Relief Cuts

In certain embodiments relief cuts may also be necessary or useful during hydraulic shearing to aid and control proper and accurate cleaving or shearing of the concrete and it's aggregate. To effectuate relief cuts, the material passes under a saw set to cut multiple parallel cuts at a predetermined depth into the material. Then the direction of travel of the material may be changed before passing the material under a planer. The planer extracts material defined by the relief cuts leaving the core piece of material in tact.

### Finishing

Once the recycled concrete is in block form it may be turned on its side or top side down manually or by mechanical means on a conveyor belt or mechanical apparatus. The unfinished bottom of the recycled concrete block can pass through a saw or any one of a number of machines to produce a desired finish on the final surface. The recycled concrete block may be passed through a finishing line. This would entail any one of a number of machines such as: a tolerance milling machine, a scarifier grinder, diamond grinders, shot blasting, or another set of saws, to produce the desired texture, style, shape, or color.

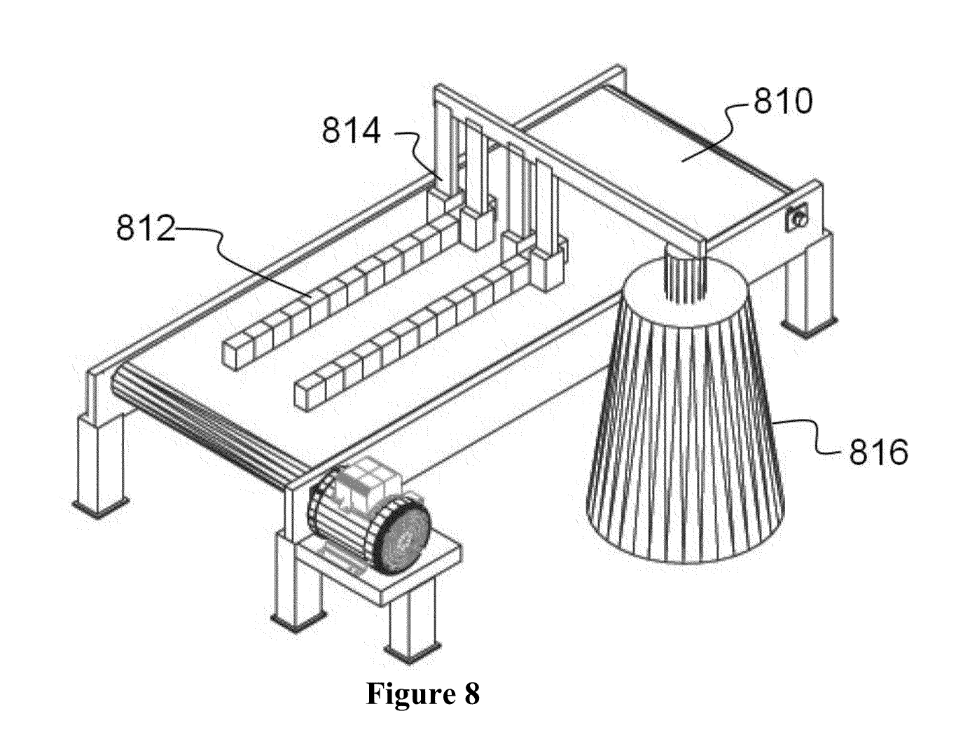

FIG. 8 depicts one embodiment of a finishing line. A conveyer 810 carrying a load of cut material 812 such as concrete moves the material 812 between applicators 814. The applicators apply either by brushing or spraying, a coating which may be a stain, weatherproofing or coloring material. A reservoir 816 containing the finish coating is coupled to the applicators 814 to provide sufficient coating for the volume of the finishing line.

### Portability

In certain embodiments of the present disclosure portions of the disclosed machinery may be built on a trailer or a metal skid or platform that may be loaded on a trailer or truck and moved to a desired location. This has the affect of providing for field operation of some or all of the methods disclosed herein. For example and without limitation, devices may be transported to a job site and pavement removed and processed. In certain embodiments only some of the processing may be done at the job site and the remainder done at another site. Trailer mounting may provide for easy transportation whereas mounting on a skid or other platform may reduce costs. The inventor contemplates a system wherein one or more devices including conveyer belts, mills and saws are delivered to a job site and final cut bricks are transported away after processing. However, this application should not be read to limit the disclosure to only a single embodiment.

The above illustration provides many different embodiments or embodiments for implementing different features of the invention. Specific embodiments of components and processes are described to help clarify the invention. These are, of course, merely embodiments and are not intended to limit the invention from that described in the claims. Moreover the attached appendix, which is incorporated herein by reference, includes alternative embodiments.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following provisional claims.

I claim:

1. A device comprising:
a first conveyor belt, said first conveyer belt operable to transport a load through one or more first saw blades, said saw blades disposed above the first conveyer belt;
a rotator operable to convey material from the first conveyer belt to a second conveyer belt and rotate the material;
a milling assembly adjustably disposed above either the first conveyer belt or the second conveyer belt, said milling assembly operable to mill away at least a portion of load on the either conveyer belt.

2. The device of claim 1 wherein at least one of the conveyer belts include cleats.

3. The device of claim 1 wherein the load is hardened concrete.

4. The device of claim 1 further including:
one or more second saw blades, said second saw blades disposed above at least one of the conveyer belts.

5. The device of claim 1 further including:
one or more second saw blades, said second saw blades disposed above the second conveyer belt.

6. The device of claim 1 wherein said rotator includes a staging area and an actuator, said actuator operable to transfer the load from the first conveyer belt to the second conveyer belt.

7. The device of claim 1 further including one or more applicators, said applicators coupled to a reservoir for applying a coating to the load.

8. The device of claim 7 wherein the coating is at least one of either a stain or a weatherproofing.

9. The device of claim 1 wherein the height of the saw blades is adjustable.

10. A method comprising the following steps:
receiving an amount of hardened concrete;
milling away a portion of the concrete;
sawing the concrete along a first direction;
rotating the concrete, and
sawing the concrete along a second direction.

11. The method of claim 10 wherein the rotating is substantially ninety degrees rotation.

12. The method of claim 10 wherein the sawing partially cuts the concrete.

13. The method of claim 10 wherein the sawing cuts completely through the concrete.

14. The method of claim 10 wherein the step of rotating is effectuated using a staging area and an actuator to move the concrete from a first conveyer to a second conveyer.

15. The method of claim 10 further including:
applying a coating to the concrete.

16. The method of claim 15 wherein the coating is either a stain or weatherproofing.
